(19) United States
(12) Patent Application Publication
(10) Pub. No.: US 2004/0146154 A1
(43) Pub. Date: Jul. 29, 2004

(54) Connection between communication networks using different signaling protocols

(76) Inventors: Mohammad-Jalil Ahmadyar, Landsberg am Lech (DE); Klaus Bachner, Munchen (DE); Wolfgang Endler, Zomeding (DE); Wolfgang Kuhn, Stockdorf (DE)

Correspondence Address: MORRISON & FOERSTER LLP, 1650 TYSONS BOULEVARD, SUITE 300, MCLEAN, VA, 22102, US

(21) Appl. No.: 10/474,673

(22) PCT Filed: Apr. 9, 2002
(86) PCT No.: PCT/DE02/01312

(30) Foreign Application Priority Data
Apr. 11, 2001 (DE) 101 18 211.2
Aug. 8, 2001 (DE) 101 38 915.9

(51) Int. Cl. H04J 3/16; H04M 7/00

(52) U.S. Cl. 379/229; 379/220.01; 370/467

(57) ABSTRACT

The invention relates to a method and a device for adapting different signalling protocols in fixed telephone networks and/or mobile radio networks (N1, N2). According to the invention, networks of various carries are connected together via a gateway (10) as opposed to an international gateway exchange (12).

The invention is in the field of mobile radio networks and fixed telephone networks and relates to the signaling protocols employed which partially differ.

The invention relates in particular to a method and a protocol converter for adapting different signaling protocols and further relates to a method for controlling a switching connection between at least two networks which can employ different signaling protocols.

The connection between communication networks of different operators (also called carriers) in different countries is usually effected over international, central switching centers (also referred to below as gateway exchanges). A separate signaling protocol is employed in each of the operators' networks and different operators' signaling protocols usually differ from each other. Each country has an international gateway exchange to which the national networks can be connected in accordance with the national signaling protocol of the respective country.

An internationally standardized signaling protocol is employed between the international gateway exchanges, with the international gateway exchanges logically forming a separate international communication network. This network is usually not fully meshed so that a connection between two national operators is frequently established over several international gateway exchanges. The intermediately switched international gateway exchanges function here as international transit exchanges.

The networks of the national operators are customarily connected to the relevant country's international gateway exchanges over national trunk groups. Alternatively a national operator's network can be connected to the network of another national operator in the same country, which is in turn connected to this country's international gateway exchange. In this case international calls are forwarded to the relevant country's international gateway exchange over the other national operator's network.

What is termed a Network Identifier is provided to identify the signaling protocol. This provides four values, two of which are reserved for identifying national signaling protocols and two of which are reserved for identifying international signaling protocols.

The international signaling protocol between the international gateway exchanges is designated INAT0, the national signaling protocol of each operator is designated NAT0, and the signaling protocol for connecting two national operators is designated NAT1. The fourth identifier, namely INAT1, is at present scarcely used.

The network architecture hitherto requires the mandatory use of international gateway exchanges with intermediately connected international signaling for connecting networks of national operators in different countries.

The object of the invention is to disclose a way to allow networks of national operators in different countries to be interconnected without the expensive international gateway exchanges.

The object is achieved by means of the features of the invention.

According to the invention a gateway is provided for adapting national signaling protocols. A method for adapting national signaling protocols is also disclosed.

The object is achieved in particular by means of a method of the type mentioned at the start that employs a gateway as the central instance, with the gateway performing the following operations:

receiving signaling data of a first network at a first interface of the gateway, with the first interface corresponding with the protocol of the first network,

adapting the received signaling data to the requirements in terms of the signaling of a second network, and

transmitting the adapted signaling data over a second interface of the gateway to the second network.

The object is further achieved by means of a method for adapting different protocols in networks, with a gateway which performs the three operations just described being introduced as a central instance.

An achievement of the object further comprises a switching system for controlling a connection setup and cleardown of individual system components consisting of:

a plurality of networks,

a plurality of umbrella systems represented in each case by a gateway exchange,

wherein a network has to be assigned to at least one umbrella system and wherein the networks are able to employ different signaling protocols, and

a gateway as a central switching instance to which at least a part of the system components are connected, having:

a receive unit for receiving signaling data of a first network at a first interface of the gateway, with the first interface corresponding with the protocol of the first network,

a conversion unit for adapting the received signaling data to the requirements in terms of the signaling of a second network, and

a transmission unit for transmitting the adapted signaling data over a second interface of the gateway to the second network.

The protocol converter according to the invention for converting signaling protocols of several networks comprises:

a plurality of interfaces which each implement a signaling protocol of a network, and

means for converting the signaling protocols by converting the respective protocol parameters which determine how, for example, addresses, formats, coding, processing speeds etc. are handled.

The protocol converter thus converts protocols, in particular signaling protocols, between units that have not been adapted in terms of the protocols. It can be embodied in the form of software or hardware or in hybrid forms.

An achievement of the object according to claim 17 consists of a computer-readable medium for storing computer software which, if loaded on a computer employed as a gateway, will cause that computer to perform the following operations:

receive signaling data of a first network at a first interface of the gateway, with the first interface corresponding with the protocol of the first network,

adapt the received signaling data to the requirements in terms of the signaling of a second network, and

transmit the adapted signaling data over a second interface of the gateway to the second network.

The gateway according to the invention comprises a plurality of interfaces on which in each case a specific signaling protocol is employed. This signaling protocol can be, for example, the national signaling protocol NAT0 of a national operator or the national signaling protocol NAT1 for connecting two national operators or the international signaling protocol INAT0 for connecting international gateway exchanges. According to the invention it is also possible to use an international signaling protocol designated INAT1. The gateway further comprises means for converting between the signaling protocols employed.

The method for adapting national signaling protocols comprises the following operations:

In a first step, signaling data is received which is received in the gateway at a first interface to a first national network and which is transmitted by the network to the gateway according to the rules of the signaling protocol employed in the first national network.

In a second step, the received signaling data is adapted in the gateway to the requirements of the specific second network of a second national operator to which it is to be transmitted.

In a third step, the adapted signaling data is transmitted in the gateway over a second interface to the second national network according to the rules of the signaling protocol employed in the second national network.

The use of international gateway exchanges for connecting networks of national operators in different countries is advantageously eliminated because the national networks are connected directly to the gateway with their respective national signaling protocol.

The existing international gateway exchanges in the respective countries are furthermore advantageously relieved because the national signaling protocols transmitted to the gateway according to the invention are no longer transmitted to the respectively assigned international gateway exchange.

Advantages emerge from the fact that a standardized intermediate protocol, such as the INAT0 signaling protocol, is employed for converting or adapting. In this case, storage of the signaling data in the intermediate protocol or extraction of the signaling data from the intermediate protocol is all that is required for each national signaling protocol. Otherwise required expensive direct conversion to all other connected signaling protocols is rendered superfluous.

When a national network is linked with the aid of a national signaling protocol, the specific signaling data otherwise provided by the respectively assigned international gateway exchange of the relevant country is advantageously added in the gateway according to the invention. As an instance, the respective national code (also called ‘country code’, such as 0049 for Germany) is inserted into corresponding incoming signaling data so that the possibility of an international callback is retained even when national networks are connected in different countries.

Generally, all the features that would otherwise be provided by the national gateway exchange, such as manipulation of the A and B number and connected number and the handling of country-specific messages or parameters, are ported by the invention to the gateway level so that they are also available there.

When carriers in different countries are connected, all nationally specific signals are either filtered or processed or converted in such a way that they can be understood by the (signaling protocol of the) second network.

A further advantage lies in linking the gateway according to the invention to an international gateway exchange since in this way access is provided to those national networks that are not connected to the gateway according to the invention.

The gateway is preferably linked to an international gateway exchange with the aid of an international signaling protocol designated INAT1. This allows the signaling data to be assigned and/or processed in the gateway and in the international gateway exchange in accordance with this designation.

Different carriers in different countries have hitherto always been coupled via the respective gateway exchange(s) in those countries. According to the invention the carriers can now be connected directly via the gateway without having to switch a gateway exchange intermediately. This on the one hand increases the efficiency of the connection; on the other hand there is a significant cost advantage from not connecting a gateway exchange.

Depending on the required application, either all the gateway exchanges or only a part of the gateway exchanges can be connected to the gateway.

Additional, advantageous embodiments emerge from the subclaims.

Further advantages of the invention and a particular embodiment, together with its features, are shown in the detailed description of figures below.

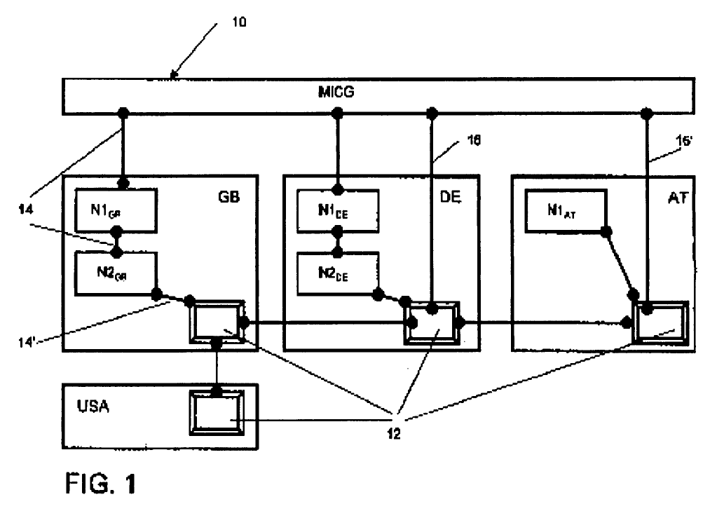

FIG. 1 shows an international communication network architecture with a gateway according to the invention,

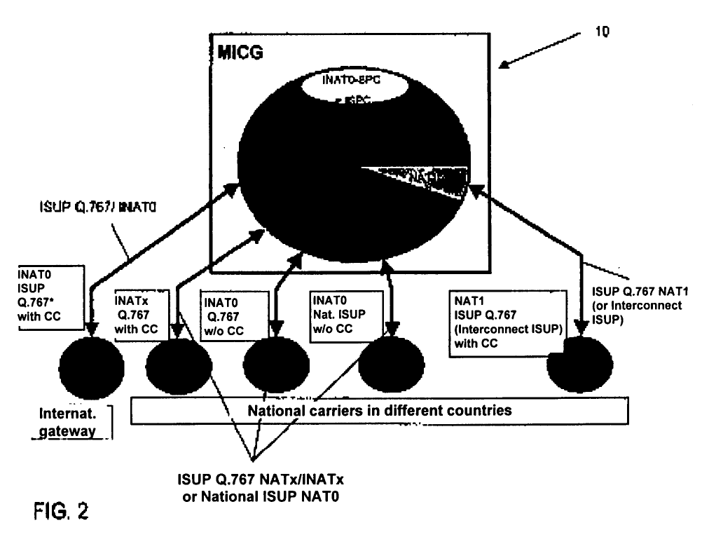

FIG. 2 shows a gateway according to the invention in a block diagram.

The following designations are employed in the figures:

| | |
|---|---|
| INATX | Network Identifier X of an international signaling protocol |
| NATX_{yy} | Network Identifier X of a national signaling protocol in |
| | country YY |
| SPC | Signaling Point Code |
| TGN | Telecom Global Network |
| MICG | Multi InterConnectable Gateway |
| ISUP | ISDN User Part |
| ISDN | Integrated Services Digital Network |
| CC | Country Code |
| GB | Great Britain |
| DE | Germany |
| US | United States of America |
| AT | Austria |
| NX_{yy} | National network of operator X in country YY |
| IKA_{yy} | International gateway exchange of country YY |

The basic structure of several national carriers connected via the gateway according to the invention is described as a brief introduction below with reference to FIG. 1.

The gateway 10 is introduced as a central switching instance. In each of the participating countries there can be one or, in most cases, several national networks N operated by several carriers. These national networks N must be interconnected in switching terms.

Each country furthermore has an international gateway exchange 12. The respective international gateway exchanges 12 are for their part interconnected. A part of the international gateway exchanges 12 can be connected to the gateway 10. In other cases, one or more national network(s) N can be connected to the gateway 10.

The connections of the national networks N are represented by a national Network Identifier 14, 14′ of a national signaling protocol.

The connections between the national networks N and the relevant international gateway exchange 12 are in their turn represented by a further national Network Identifier 14′ of a national signaling protocol. In the preferred embodiment the National Identifier NATX 14, 14′ is formed from NAT0 and NAT1.

The connections between an international gateway exchange 12 and the gateway 10 are represented by an international Network Identifier 16, 16′ which in FIG. 2 is also called INATX. The international Network Identifier 16, 16′ also represents the connection between the relevant international gateway exchanges 12.

If, for example, a network of a national British carrier N1_{GB} is to be connected to a network of a German carrier N2_{DE} then—in contrast to the method according to the prior art—according to the invention this no longer has to be effected via the British and German gateway exchange 12; it can instead be effected directly via the gateway 10 according to the invention. This has a significant cost advantage as expensive process overhead by gateway exchanges 12 can be dispensed with.

ISUP designates the ISDN User Part and contains the coding, functions, and protocols for the signaling of a specific user. The User Parts control, for example, the setup and cleardown of user information channels and the implementation of features or services, and perform management and monitoring functions.

The method and system according to the invention permit the efficient use of different signaling systems, such as MFC R1, MFC R2, No.5, and SS#7, all produced according to the ITU-T guidelines. SS#7 is used for ISDN and in mobile radio networks and relates to an outband system where the signaling system operates totally separately from the transmission of user data. Signaling System SS#7 of the preferred embodiment has a meshed structure. Other signaling systems can, however, also be considered for the method according to the invention. The method according to the invention can then also be used to automatically and indirectly connect the users of the networks of different carriers alongside the networks themselves.

According to the invention, different protocol worlds can be adapted by translating all conventions relating to semantics, syntax, formats, time flows etc. into a standardized working or intermediate protocol.

An example of an interconnect ISUP is the NAT1 national signaling protocol standardized in Germany. This is also referred to as ZZN#7 (standing for ‘Zeichengabe Zwischennetz’—meaning ‘intermediate network signaling’—#7) and is employed between the national carriers.

The gateway 10 can provide all possible connection variants of ISUP, such as a connection of NAT0 and NAT0, NAT0 and NAT1, NAT0 and INAT0, and NAT0 and INAT1 etc.

The general structure of the system according to the invention will be explained with the aid of an exemplary embodiment with reference to FIG. 2:

Over its various interfaces (INATX, NATX, . . . ), the gateway 10, also referred to here as MICG (Multi InterConnectable Gateway) 10, connects different carriers in different countries to each other and to any gateway exchanges or to international gateways. The MICG 10 can therefore in particular set up a connection between different carriers in different countries via the ISUP Q.767 protocol with the Network Identifier NATX. It furthermore serves to connect a carrier to an own or foreign international gateway. The ISUP Q.767 protocol with the Network Identifier INATX is employed here.

The abbreviation CC in FIG. 2 serves to designate the “country code” of the respective country. SPC1, SPC2, and SPC3 refer to a Signaling Point Code (SPC). SPC1 designates a bilateral Signaling Point Code between a Telecom Global Network (TGN) and a national carrier. SPC2 is part of a national carrier network in another country, and SPC3 is the same as SPC2. The Signaling Point Code can also be taken to be the address, unique on a country-specific basis, of a switching instance or exchange.

In the preferred embodiment the network is a mobile radio network based in particular on the GSM (Global System Mobile) or DCS (Digital Communications Systems) standard, or an ISDN network, and is operated by a carrier, in particular a national carrier.

It must be emphasized that the representation of components relevant to the invention must basically not be regarded as restrictive. It is particularly obvious to a relevant person skilled in the art that a term such as ‘gateway’ must be understood in a functional, not physical sense. This means, for instance, that a gateway can also be partially or fully implemented in software and/or distributed over several physical devices.

1. Method for controlling a switching connection between at least two networks (N1, N2) which can employ different signaling protocols, wherein a gateway (10) is introduced as a central instance performing the following operations:
receiving signaling data of a first network (N1) at a first interface of the gateway (10), with the first interface corresponding with the protocol of the first network (N1),
adapting the received signaling data to the requirements in terms of the signaling of a second network (N2), and
transmitting the adapted signaling data over a second interface of the gateway (10) to the second network (N2).

2. Method for adapting different signaling protocols in networks (N1, N2), wherein a gateway (10) is introduced as a central instance performing the following operations:
receiving signaling data of a first network (N1) at a first interface of the gateway (10), with the first interface corresponding with the protocol of the first network (N1),
adapting the received signaling data to the requirements in terms of the signaling of a second network (N2), and
transmitting the adapted signaling data over a second interface of the gateway (10) to the second network (N2).

3. Method according to one of the preceding claims, characterized in that
the networks (N1, N2) to be connected employ different signaling protocols.

4. Method according to one of the preceding claims, characterized in that
the method at the beginning comprises the following operation:
automatically registering rules of the signaling protocol of the first network (N1) and rules of the signaling protocol of the second network (N2).

5. Method according to one of the preceding claims, characterized in that
the network is a mobile radio network, based in particular on the GSM (Global System Mobile) or DCS standard or is an ISDN network, and is operated by a carrier, in particular a national carrier.

6. Method according to one of the preceding claims, characterized in that
the method employs a standardized intermediate protocol.

7. Method according to one of the preceding claims, characterized in that
the method connects networks (N1, N2) of different carriers employing different signaling protocols in different countries.

8. Method according to one of the preceding claims, characterized in that
the signaling protocol relates to an outband system, in particular the Signaling System No. 7 (SS#7).

9. Method according to one of the preceding claims, characterized in that
the method comprises a national Network Identifier (14, 14′) and international Network Identifier (16, 16′) whose purpose is to identify the signaling protocols.

10. Switching system for controlling a connection setup and cleardown of individual system components consisting of:
a plurality of networks (N1, N2),
a plurality of umbrella systems represented in each case by a gateway exchange (12),
wherein a network has to be assigned to at least one umbrella system and wherein the networks (N1, N2) are able to employ different signaling protocols, and
a gateway (10) as a central switching instance to which at least a part of the system components are connected, having:
a receive unit for receiving signaling data of a first network (N1) at a first interface of the gateway (10), with the first interface corresponding with the protocol of the first network (N1),
a conversion unit for adapting the received signaling data to the requirements in terms of the signaling of a second network (N2), and
a transmission unit for transmitting the adapted signaling data over a second interface of the gateway (10) to the second network (N2).

11. System according to claim 10, characterized in that
the network is a mobile radio network, based in particular on the GSM or DCS standard and operated by a carrier, in particular a national carrier.

12. System according to one of the claims 10 or 11, characterized in that
the signaling protocol is an outband system, in particular the Signaling System No. 7 (SS#7).

13. System according to one of the preceding claims 10 to 12, characterized in that
each network (N1, N2) and/or at least a part of the gateway exchanges (12) is/are connected to the gateway (10).

14. System according to one of the preceding claims 10 to 13, characterized in that
the connection between the networks (N1, N2) is not effected via the relevant gateway exchanges (12) of the networks but exclusively via the gateway (10).

15. System according to one of the preceding claims 10 to 14, characterized in that
the adapted signaling data is supplemented with additional data concerning the relevant countries, in particular with the data which would be provided by the relevant gateway exchange (12) such as a country code.

16. Protocol converter for converting signaling protocols of several networks (N1, N2) comprising:
a plurality of interfaces each implementing a signaling protocol of a network,
means for converting the signaling protocols.

17. A computer-readable medium for storing computer software which, if loaded on a computer employed as a gateway (10), will cause that computer to perform the following operations:
receive signaling data of a first network (N1) at a first interface of the gateway (10), with the first interface corresponding with the protocol of the first network (N1),
adapt the received signaling data to the requirements in terms of the signaling of a second network (N2), and
transmit the adapted signaling data over a second interface of the gateway (10) to the second network (N2).
